(19) United States
(12) Patent Application Publication
(10) Pub. No.: US 2014/0265048 A1
(43) Pub. Date: Sep. 18, 2014

(54) CARTRIDGE FOR AN ADDITIVE MANUFACTURING APPARATUS AND METHOD

(71) Applicant: Matterfab Corp., Bloomington (IN)

(72) Inventors: Matthew Burris, Bloomington, IN (US); Andrew Dolgner, Bloomington, IN (US)

(73) Assignee: Matterfab Corp., Bloomington (IN)

(21) Appl. No.: 14/213,661

(22) Filed: Mar. 14, 2014

Related U.S. Application Data
(60) Provisional application No. 61/787,659, filed on Mar. 15, 2013.

(51) Int. Cl. B29C 67/00

(52) U.S. Cl. CPC B29C 67/0088
USPC 264/497

(57) ABSTRACT

One variation of a method for constructing a three-dimensional structure within a additive manufacturing apparatus includes: reading an identifier from a cartridge transiently loaded into the additive manufacturing apparatus; initiating a build cycle; dispensing a layer of powdered material from the cartridge into a build chamber of the additive manufacturing apparatus; during the build cycle, selectively fusing regions of the layer; in response to completion of the build cycle, dispensing a volume of loose powdered material from the build chamber into the cartridge; and over a computer network, updating a computer file with data pertaining to the build cycle, the computer file specific to the cartridge and accessed according to the identifier.

### CROSS-REFERENCE TO RELATED APPLICATIONS

The application claims the benefit of U.S. Provisional Patent Application No. 61/787,659, filed on 15, Mar. 2013, which is incorporated in its entirety by this reference.

### TECHNICAL FIELD

This invention relates generally to selective laser sintering and more specifically to a new and useful cartridge for an additive manufacturing apparatus and method in the field of selective laser sintering.

### BRIEF DESCRIPTION OF THE FIGURES

FIG. 1 is schematic representations of an additive manufacturing apparatus of one embodiment of the invention;

FIG. 2 is a schematic representation of one variation of the additive manufacturing apparatus;

FIG. 3 is a schematic representation of one variation of the additive manufacturing apparatus;

FIG. 4 is a schematic representation of one variation of the additive manufacturing apparatus;

FIGS. 5A and 5B are schematic representations of a cartridge of one embodiment of the invention;

FIG. 6 is a flowchart representation of one variation of a method of one embodiment of the invention;

FIG. 7 is a flowchart representation of one variation of the method;

FIG. 8 is a flowchart representation of one variation of the method; and

FIG. 9 is a flowchart representation of one variation of the method.

### DESCRIPTION OF THE EMBODIMENTS

The following description of the embodiment of the invention is not intended to limit the invention to these embodiments, but rather to enable any person skilled in the art to make and use this invention.

### 1. Additive Manufacturing Apparatus and Applications

As shown in FIG. 1, an additive manufacturing apparatus 100 for additively manufacturing three-dimensional structures (i.e., objects) includes: a receiver 150 accepting a cartridge containing powdered material; a build chamber 120 including a build platform 122; a material dispenser 180 distributing a layer of powdered material—from the cartridge 200—over the build platform 122; a laser output optic 130 outputting an energy beam toward the build platform 122; and an actuator 124 maneuvering the laser output optic 130 over the build platform 122 to scan an energy beam across layers of powdered material dispensed over the build platform 122.

Generally, the apparatus functions as an additive manufacturing device capable of constructing three-dimensional structures by selectively fusing regions of deposited layers of powdered material. As described in U.S. patent application Ser. No. 14/212,875 in a scan mirror configuration, the apparatus manipulates a laser output optic 130 relative to a build platform 122 and selectively outputs a beam of energy toward a rotating mirror, which projects the intermittent energy beam onto a lens which subsequently focuses the beam onto the layer of material deposited over the build platform 122 to selectively melt areas of the powdered material, thereby “fusing” select areas of the layer of the powdered material. In a gantry configuration, the apparatus manipulates the laser output optic 130 relative to the build platform 122 and selectively outputs a beam of energy directly toward the layer of material deposited over the build platform 122 to selectively melt areas of layer of the powdered material. In the foregoing configurations, the apparatus can implement similar methods to simultaneously or asynchronously project a second energy beam onto select fused areas of each layer of powdered material within the build chamber 120, thereby anneal these volumes of fused material.

The additive manufacturing apparatus 100 can also include multiple laser diodes (or electron guns or beam generators) and/or multiple laser output optics to enable simultaneous projection of multiple discrete energy beams toward a layer of powered material to simultaneously preheat, melt, and/or anneal multiple regions of the material. For example, the material dispenser 180 can dispense layer after layer of powered material in to the build chamber 120, and the actuator 124 can scan energy beams from the laser output optic 130 and energy beams from the second laser output optic 130 over the build platform 122 to melt and then anneal, respectively, select regions of each layer before a subsequent layer is deposited thereover. The additive manufacturing apparatus 100 can further incorporate multiple discrete laser diodes to generate multiple discrete energy (e.g., laser) beams, which can be simultaneously projected onto a layer of powered material, thereby enabling simultaneous fusion (or stress relief) of multiple areas of the layer of powered material. The multiple discrete laser diodes can also be grouped into an array (e.g., a close-pack array) to enable fusion (or stress relief) of a larger single area of the layer, or the multiple discrete energy beams can be grouped into a single composite beam of higher power to enable higher energy beam scanning speeds during a build cycle. Therefore, the additive manufacturing apparatus 100 can incorporate multiple relatively low-power laser diodes to achieve power (or energy) densities at laser sintering sites on layers of powdered material approximating power (or energy) densities of a single higher-power laser diode 132. The additive manufacturing apparatus 100 can also control output parameters of the various laser diodes to customize laser interaction profiles, energy densities, power, etc. at and around a laser sintering site, such as based on a material contained in the cartridge 200 loaded into the apparatus, a measured temperature of a fused region of a dispensed layer of powered material, a scan direction of an energy beam over the build platform 122, etc.

### 1.1 Build Chamber

As described in U.S. patent application Ser. No. 14/212,875, the build chamber 120 of the additive manufacturing apparatus 100 includes the build platform 122. Generally, the build chamber 120 defines a volume in which a part is additively constructed by selectively fusing areas of subsequent layers of powdered material deposited and leveled therein. The build chamber 120 can include a build platform 122 coupled to a vertical (i.e., Z-axis) actuator 125 that vertically steps the build platform 122 (downward) as additional layers of powdered material are deposited and leveled over previous layers of material by the material dispenser 180, thereby maintaining a substantially constant distance between the laser output optic 130(s) and a top surface of a topmost layer of powdered material for each deposited layer.

In one implementation, the build chamber 120 defines a parallel-sided rectilinear volume, and the build platform 122 rides vertically within the build chamber 120 and creates a powder-tight seal against the walls of the build chamber 120. In this implementation, the vertical interior walls of the build chamber 120 can be mirror-polished or lapped to external vertical sides of the build platform 122 to prevent powdered material deposited onto the build platform 122 from falling between the build platform 122 and the build chamber 120 walls and to prevent horizontal disruption of powdered material dispensed across the build platform 122 as the vertical height of the build platform 122 is indexed downward as each new layer is deposited. Alternatively, the build platform 122 can include a scraper, a spring steal sealing ring, and/or an elastomer seal or bushing that rides between the build platform 122 and the walls of the build camber to prevent powdered material from falling passed the build platform 122. The build platform 122 and vertical walls of the build chamber 120 can also be of substantially similar materials, such as stainless steel, to maintain substantially consistent gaps between mating surfaces (or seals) of the build chamber 120 walls and the build platform 122 throughout various operating temperatures within the build chamber 120. However, the build chamber 120 and the build platform 122 can be of any other material (e.g., aluminum, alumina, glass, etc.), any other shape of geometry (e.g., rectilinear, cylindrical), and/or mate in any other suitable way.

As described above, the build platform 122 can be coupled to a Z-axis actuator 125, which functions to move the build platform 122 vertically within the build chamber 120, as shown in FIG. 1. For example, the Z-axis actuator 125 can include a lead screw, ball screw, rack and pinion, pulley, a linear motor, or other suitable mechanism powered by a servo, stepper motor, or other suitable type of actuator. The Z-axis actuator 125 can also include a multi-rail and multi-drive system that maintains the build platform 122 in a substantially perpendicular position relative to the build chamber 120 walls, normal to a laser output optic 130, and/or at a constant vertical position relative to the laser output optic 130 during selective melting of areas of various layer of powdered material during a build cycle.

In one implementation, the actuator positions the build platform 122 vertically within the build chamber 120 at a resolution of 20 μm to 100 μm with an approximate step size of 1 μm-5 μm. The Z-axis actuator 125 can also leverage weight of additional layers of powdered material deposited over the build platform 122 during a part build cycle to stabilize the build platform 122.

The build chamber 120, the build platform 122, the Z-axis actuator 125, and/or various other components of the additive manufacturing apparatus 100 can be arranged within a casing 110, such as described in U.S. patent application Ser. No. 14/212,875 filed on 14, Mar. 2014, which is incorporated in its entirety by this reference. Furthermore, as shown in FIG. 1, the additive manufacturing apparatus 100 can include a door 112 into the build chamber 120 such that, once construction of a part is completed within the build chamber 120, the door 112 can be opened for removal of the part, such as manually by a user or automatically by a robotic conveyor.

### 1.2 Material Handling and Material Dispenser

The additive manufacturing apparatus 100 also includes a powder system that receives one or more cartridges containing powdered material, that meters a particular amount of powdered material from the cartridge 200(s) into the build chamber 120, and that levels each metered amount of powdered material into a layer of powdered material over the build platform 122 or over a previous layer of powdered material.

Generally, once a cartridge is installed in the machine and a build cycle for a part is initiated, a material dispenser 180 draws powdered material out of the cartridge 200 and distributes the powdered material across the build platform 122 as a first layer of substantially constant thickness. The laser diodes, laser output optics, and actuators then cooperate to preheat, melt, and/or anneal select areas of the layer of powdered material by selectively projecting one or more energy beams onto the deposited layer. Once a scan of the current layer is completed, the Z-axis actuator 125 indexes the build platform 122 vertically downward, the material dispenser 180 distributes a second layer of powdered material over the first layer of powdered material, and the laser diodes, laser output optics, and actuators again cooperate to preheat, melt, and/or anneal select areas of the second layer of powdered material by selectively projecting one or more energy beams onto the deposited layer. This procedure repeats until the part is completed and the build cycle finished.

For each additional build layer deposited into the build chamber 120 during construction of a three-dimensional structure, the material dispenser 180 meters a particular volume, mass, and/or weight of material from the cartridge 200 and distributes this portioned amount of powdered material evenly over the build platform 122 (or over a preceding layer of material) to yield a flat and level layer of constant (or controlled) thickness with a top surface of the layer at a consistent and repeatable distance from the laser output optic 130. For example, the material dispenser 180 can include a recoater blade 182 that moves horizontally across the build chamber 120 to distribute powdered material evenly across the build platform 122. In particular, the Z-axis actuator 125 can set move the build platform 122—or a previously-leveled layer of powdered material—to a vertical position offset below the recoater blade 182, the receiver can dispense a volume of material on the build platform 122, and the material dispenser 180 can sweep the recoater blade 182 across the build platform 122—or the previously-leveled layer of powdered material—to level the volume of material into a layer of a particular thickness. The recoater blade 182 can accept replaceable blades or include a fixed or permanent leveling blade. The material dispenser 180 can also implement closed-loop feedback to control a position or speed of the recoater blade 182, such as based on a power consumption of an actuator motivating the recoater blade 182 during a leveling cycle, to identify and/or reduce disruption of previous layers of material and/or to prevent damage to previously-fused regions of prior material layers.

Once the build cycle is complete, the material dispenser 180 can recycle loose (is unfused, remaining) powdered material from the build chamber 120 back into the cartridge 200. For example, once the build cycle is complete, the material dispenser 180 can collect loose powder from the build chamber 120, pass this loose powder through a filtration system, and return the filtered material back into the cartridge 200. In this example, the material dispenser 180 can include a vacuum that sucks loose powdered material off of the build platform 122, passes this material over a weight-based catch system or filter, and dispenses this filtered material into the cartridge 200 via an inlet. In another example, once the build cycle is complete, the material dispenser 180 can drain loose powder from the build chamber 120 via gravity, filter this loose powder, and return this filtered powder to the powder cartridge via a mechanical lift system, such as a screw conveyor. In this example, the build chamber 120 can include a drainage port 128 proximal its bottom (e.g., opposite the laser output optic 130), and the Z-axis actuator 125 can drop the build platform 122 downward passed the drainage port 128 to expose the drainage port 128 to the build chamber 120. Loose material can thus flow out of the build chamber 120 through the drainage port 128 via gravity and can then be collected, filtered, and returned to the cartridge 200. In this example, a blower arranged over the build platform 122 or a vacuum coupled to the drainage ports 128 can compel any remaining loose material through the drainage ports 128 and/or decrease drainage time of the loose material from the build chamber 120. The Z-axis actuator 125 or other actuator within the additive manufacturing apparatus 100 can also tilt or tip the build platform to further assist dispensation of loose powdered material from the build chamber 120, such as by inclining the build platform 120 toward an exposed or open drainage port 128. Furthermore, in these examples, the additive manufacturing apparatus 100 can identify an appropriate filter type for the powdered material dispensed from the cartridge—such as based on a data collected directly from the cartridge or extracted from computer file associated with the cartridge according to a cartridge identifier, as described below—and then pass material additive manufacturing apparatus 100 from the build chamber through a particular filter selected according to a filter type callout before dispensed the recycled material back into one or more cartridges. The material dispenser 180 can also implement a screw, conveyor, lift, ram, plunger, and/or gas-, vibratory, or gravity-assisted transportation system to return recycled powdered material to the cartridge 200, to another cartridge, or to an other material holding system.

In one variation, the powder system includes a receiver 150 that interfaces with a sealed cartridge to feed fresh or recycled material into the apparatus. In this variation and as described below, the cartridge 200 defines a storage container for a particular type of material (e.g., 7075 aluminum or 316L stainless steel) or a combination of types of materials (e.g., a mixture of pure aluminum, pure copper, pure nickel, and pure magnesium) in powdered form. Once dispensed from the cartridge 200 into the build chamber 120, regions serial layers of the powdered material can be selectively melted to create a three-dimensional structure. The cartridge 200 can contain the powdered material within a sealed inert environment—such as argon or nitrogen—to limit exposure to oxygen, thereby extending a working life (i.e., a shelf life) of the powdered material within. The cartridge 200 can also be resealable. For example, after being loaded into the apparatus, the cartridge 200 can be opened, powdered material removed from the cartridge 200, and the build cycle completed, at which point an inert atmosphere is reinstated within the cartridge 200 and the cartridge 200 is resealed to prolong a useable life of material remaining in the cartridge 200.

In one implementation of this variation, the receiver includes a barb 156 or prong that pierces a polymer seal arranged over an outlet 222 of the cartridge 200 when the cartridge 200 is inserted into the receiver 150, such as shown in FIG. 4. In this implementation, the receiver 150 can include an elongated housing with the prong arranged at the base of the housing, wherein manual or mechanized linear insertion of the cartridge 200 into the housing engages the prong against the polymer seal to open powder material within the cartridge 200 to the powder system within the additive manufacturing apparatus 100. Alternatively, the cartridge 200 can include a threaded boss arranged about an outlet 222, the receiver 150 can be threaded to receive the threaded boss, and the prong can be arranged within the receiver 150 such that installation of the cartridge 200 into the receiver 150 similarly causes the prong to penetrate the seal of the cartridge 200. In the foregoing implementations, once removed from the receiver 150, the polymer seal can return to a sealed position to seal an (inert) environment therein.

In another implementation, the cartridge 200 includes an outlet 222 sealed by a cap (or “lid”) such that, when the cartridge 200 is installed in the receiver 150, the material dispenser 180 removes the cap to release material from the cartridge 200. In this implementation, once the build cycle is completed, the material dispenser 180 returns the cap (or another similar cap) to the cartridge 200 to seal remaining or returned powdered material therein. However, the receiver 150 and the material dispenser 180 can include any other actuator or element that engages the cartridge 200 to release powdered material therefrom.

The receiver 150 can also include a seal that engages the cartridge 200 to isolate an outlet 222 (and/or an inlet) of the cartridge 200 from the ambient environment. In particular, the seal within the receiver 150 can isolate an inert environment maintained within the powder system (e.g., the build chamber 120 and the material dispenser 180) from an ambient environment containing oxygen. Alternatively, the cartridge 200 can similarly include a seal that engages a surface within the cartridge 200 to isolate the outlet 222 (and/or the inlet) of the cartridge 200 from ambient. However, the receiver 150 can cooperate with the cartridge 200 in any other way to isolate powdered material contained within the cartridge 200 from an ambient (i.e., oxygen-rich) environment.

In one implementation, the receiver 150 includes a beam element extending outward from the additive manufacturing apparatus 100, and the cartridge 200 includes a hook, eyelet, or similar feature that receives the beam element. In this implementation, an operator may hang the cartridge 200 from the beam element via the hook and then manually push the cartridge 200 along the beam element to install the cartridge 200 in the receiver 150. For example, the cartridge 200 can hold an internal volume of one half a U.S. gallon and be filled with powdered stainless steel (at 75% powder density) such that the cartridge 200 weighs approximately twenty-four pounds. In this example, the beam element extending from the receiver 150 can thus aid an operator in installing a relatively heavy cartridge into the receiver. In this implementation, the beam element can be coupled to a scale (e.g., a load cell, a strain gauge), and the scale can detect a weight or mass of the cartridge 200 and its contents—and therefore the amount of powdered material contained therein—as or once the cartridge 200 is installed in the receiver 150. Alternatively, the receiver 150 can be coupled to (e.g., suspended from) a scale that measures a mass or weight of the cartridge 200, from which a material fill level of the cartridge 200 can be determined based on a known type of material contained therein.

The receiver 150 can also accept multiple cartridges. In one example, the receiver 150 accepts a series of cartridges installed linearly therein, and the material dispenser 180 sequentially dispenses material from each of the series of cartridges as each cartridge is serially emptied into the build chamber 120. In this example, the material dispenser 180 can sequentially open each of the series of cartridges as previous cartridges are emptied by shifting a prong, cap remover, or other actuator to along the series of cartridges arranged statically within the receiver 150. Alternatively, the prong, cap remover, or other actuator can be static within the apparatus, and the receiver 150 can index a full cartridge forward into a dispense position once a leading cartridge is fully emptied. In this example, the receiver 150 can invert an emptied cartridge to enable the material dispenser 180 to gravity feed loose material recycled from the build chamber 120 upon completion of the build cycle back into the emptied cartridge through the same outlet through which material was previously dispensed out of the cartridge 200. Alternatively, the receiver 150 can index an emptied cartridge forward into a refill position, and the material dispenser 180 can gravity feed loose material recycled from the build chamber 120 into an inlet of the emptied cartridge (opposite the outlet 222 of the emptied cartridge). Yet alternatively, the material dispenser 180 can gravity feed powdered material out of a cartridge and pump recycled loose material back into the cartridge 200, as shown in FIG. 3, or vice versa.

In another example, the receiver 150 includes a rotary carriage in which cartridges are installed (e.g., screwed) onto the (periphery) of the carriage, and an actuator rotates the carriage to move cartridges from a holding position into a dispense position (and into a refill position). In this example, the carriage can be arranged such that a fresh cartridge is rotated into a vertical dispense position such that powdered material can gravity feed out of an outlet 222 of the cartridge 200. When the cartridge 200 is emptied, the carriage rotated the empty cartridge out of the dispense position as a new fresh cartridge moves into the dispense position. Furthermore, in this example, once the build cycle is complete, the carriage can continue to rotate an emptied cartridge into a refill position—such as vertically aligned with and below the dispense position—such that loose powdered material recycled from the build chamber 120 can be gravity fed back into the emptied cartridge. With a cartridge fully refilled with recycled material, the material dispense can reseal the cartridge 200 and the carriage can index the resealed cartridge forward, thus bringing another emptied cartridge into the refill position.

Yet alternatively, the receiver 150 can accept a set of cartridges and open multiple cartridges in the set, and the material dispenser 180 can dispense powdered material from the set of open cartridges substantially simultaneously and/or refill the set of cartridges with recycled material from the build chamber 120 substantially simultaneously upon completion of the build cycle. However, the receiver 150 can accept any other number of cartridges in any other sequence and/or format, and the material dispenser 180 can include any other actuator or feature to selectively dispense powdered material out of—and back into—one or more cartridges loaded into the additive manufacturing apparatus 100.

The receiver 150 can thus accept multiple cartridges containing the same or different powdered materials such that the material can be loaded into the machine in discrete volumes that are manageable (e.g., manually maneuverable) by an operator, such that oxidation is limited to a relatively small volume of powdered material pending failure of a seal in a cartridge, and/or such that discretized sealed volumes of material can be opened to the machine and used as needed, thus limiting exposure of powdered material to repeated environment changes as only smaller cartridges are opened as addition material is needed during a build cycle. Furthermore, by one or more sealed cartridges and automating unsealing and resealing procedures for these cartridges, the powder system can define a closed powder system that substantially reduces or eliminates human (e.g., operator) interaction with raw powdered materials used by the additive manufacturing apparatus 100 to construct three-dimensional structures. This closed powder system can include or accept one or more powder filters 154 (shown in FIG. 4), powder recycling systems, material dispensers, etc. The additive manufacturing apparatus 100 can also support installation of multiple cartridges simultaneously to enable use of combinations of materials within a single part, such as to create custom metal alloys on a per-layer basis.

The powder system can be further coupled to a (inert) gas supply—such as a nitrogen generator or an argon tank—and flow gas from the gas supply into the build chamber 120, through the material dispenser 180, and around an outlet 222 of the cartridge 200 to displace oxygen from volumes of the additive manufacturing apparatus 100 that contain powdered material. For example, when a build cycle is initiated and prior to unsealing a cartridge arranged in a dispense position, the powder system can open ports near high areas of trapped volumes within the laser sintering site (e.g., over the build chamber 120 and over a cartridge outlet) and flow argon through the additive manufacturing apparatus 100 to displace oxygen out of the volumes of the additive manufacturing apparatus 100 that contain, move, or are in contact with powdered material at any time before, during, or after a build cycle. Once one or more oxygen sensors within the additive manufacturing apparatus 100 indicate that an amount of oxygen remaining within the apparatus has dropped below a threshold level, powder system can close any open ports within the apparatus, and the receiver 150 can open a lid or puncture a seal over an outlet 222 of the cartridge 200 to release powdered material into the material dispenser 180. In this example, once the cartridge 200 is opened, the powder system can continue to flow argon around (and into) the cartridge 200 to displace air or other gas that may seep passed a seal between the cartridge 200 and the receiver 150 away from the cartridge 200. In this example, the powder system can additionally or alternatively maintain a positive pressure (relative to ambient) of inert gas within the apparatus to discourage ingress of air (and thus oxygen) into the additive manufacturing apparatus 100. However, the powder system can distribute any other (inert) gas through the additive manufacturing apparatus 100 and/or the cartridge 200 before, during, and/or upon completion of a build cycle to control exposure of the powdered material to oxygen (or any other gas).

The receiver 150 can further include a reader that collects identification information (an “identifier”) from the cartridge 200. For example, the reader can include a radio-frequency identification (RFID) reader and antenna that broadcast a power signal toward a cartridge as the cartridge 200 is inserted into the receiver 150 and that read an identifier (e.g., a unique serial number) thus broadcast from an RFID tag arranged on the cartridge 200. In a similar example, the reader includes a near-field communication (NFC) reader that collects identification information from a NFC tag arranged on the cartridge 200. In other examples, the reader includes a barcode scanner, a quick-response (QR) code reader, or an optical sensor and processor 160 executing machine vision to read a barcode, a QR code, or other identification information applied or printed onto the cartridge 200. As described below, the additive manufacturing apparatus 100 can then pass this identification information to a remote server—such as over a computer network—to retrieve relevant information specific to material contained in the corresponding cartridge. For example, the additive manufacturing apparatus 100 can pass a unique alphanumeric serial number read from a cartridge currently in a dispense position with the additive manufacturing apparatus 100 to a remote database to retrieve any one or more of: a type of material (e.g., 316L stainless steel, 7075 aluminum); a powder size (e.g., 4-5 μm diameter); a previously-measured or estimated quantity of powdered material within the cartridge (e.g., 6.2 lbs. or 89% capacity); an earliest manufacture date; material lot number; an original ship or delivery date; build cycle history; number of recycle cycles; fuse temperature or temperature profile; anneal temperature or temperature profile; scan speed; layer thickness; optical and/or thermal properties (e.g., emissivity) of material contained within the cartridge 200; a preferred working environment (e.g., argon, nitrogen); a maximum permissible oxygen exposure; material combination warnings; and/or cleaning instructions; etc. from a computer file associated with the cartridge 200 via the unique alphanumeric serial number. Alternatively, the additive manufacturing apparatus 100 can retrieve any of these data from a hard drive or memory incorporated into the additive manufacturing apparatus 100 (e.g., a floptical disk drive or flash memory drive), directly from a sensor arranged within the cartridge 200, and/or from a computing device connected locally to the additive manufacturing apparatus 100 (e.g., a local network computer). For example, the cartridge 200 can include a wireless transmitter that transmits stored or measured material- and/or cartridge-specific data to a local additive manufacturing apparatus over Bluetooth or Wi-Fi wireless communication protocol, and the additive manufacturing apparatus 100 can include a wireless communication module that pairs with the wireless transmitter to download any of the foregoing data directly from the corresponding cartridge (e.g., once the cartridge 200 is installed into the receiver 150). Similarly, the receiver 150 can include a plug or receptacle that engages a corresponding feature of a cartridge installed therein, and the additive manufacturing apparatus 100 can download material and cartridge information directly from the cartridge 200 over a wired connection. However, the additive manufacturing apparatus 100, the reader, and/or the receiver 150 therein can cooperate in any other way to collect material- and/or cartridge-specific information for a cartridge loaded into the additive manufacturing apparatus 100.

The additive manufacturing apparatus 100 can then implement these data during a build cycle to set build parameters, to maintain part build quality, to check build and material requirements, etc., as described below. For example, during a fuse scan, a laser diode 132 within the additive manufacturing apparatus 100 can output an energy beam of a power commensurate with a fuse laser output power defined in a computer file associated with the cartridge 200, and, during an anneal scan, the laser diode 132 can output an energy beam of a power commensurate with an anneal laser output power defined in the computer file. In another example, the Z-axis actuator 125 can index the build platform 122 vertically downward by a distance corresponding to a target layer thickness defined in a computer file downloaded directly from the cartridge 200 such that cycling the recoater blade 182 across the build platform 122 levels a volume of powdered material dispensed thereon into a layer of thickness approximating the target layer thickness. However the additive manufacturing apparatus 100 can implement data associated with the cartridge 200 and/or with material dispensed therefore in any other suitable way.

The additive manufacturing apparatus 100 can also write new data to a computer file corresponding to and/or stored on the cartridge 200. For example, the additive manufacturing apparatus 100 can write a date, a time, and a duration of a new build cycle completed with material from the cartridge 200, build cycle history of other cartridges from which material was dispensed into the build chamber 120 during the current build cycle, recycle data for material returned to the cartridge 200, etc., as described below.

As described below, the cartridge 200 can thus include one or more sensors that output signals corresponding to an atmosphere type and/or quality within the cartridge 200, a level of material within the cartridge 200, a type of material within the cartridge 200, and amount of material within the cartridge 200, cartridge tampering or leak detection, etc. For example, the cartridge 200 can include a resistance sensor, a capacitive sensor, an inductive sensor, a piezoelectric sensor, and/or a weight sensor that detect material volume, material weight, (or mass), and/or material type within the cartridge 200. In another example, the cartridge 200 includes an oxygen sensor that detects a level of oxygen within the cartridge 200 and a processor that integrates exposure to oxygen over time as a function of surface area or weight of powdered material within the cartridge 200. The cartridge 200 can also include additional sensors configured to detect one or more material properties—such as density, fuse or melting temperature, or emissivity—and/or to verify that a material loaded into the cartridge 200 matches a material code stored with the cartridge 200. Furthermore, the cartridge 200 can include temperature, humidity, and/or gas sensors to monitor life and quality of material stored within the cartridge 200 over time, such as on a regular (e.g., hourly) basis, continually, or when requested by the additive manufacturing apparatus 100 or manually by an operator.

The cartridge 200 can include a processor that monitors sensor outputs, to correlate sensor outputs with relevant data types (e.g., material temperature, internal material volume), to trigger alarms or flags for material mishandling, to handle communications to and/or from the apparatus, etc. As described above and below, the cartridge 200 can also include memory or a data storage module that stores material-related data encoded by a manufacturer or material supplier, measured locally at the cartridge 200, and/or uploaded onto the cartridge 200 by the additive manufacturing apparatus 100 before, during, and/or after a build cycle. Data transmitted between the additive manufacturing apparatus 100 and the cartridge 200 can also be encoded, encrypted, and/or authenticated by one or both of the additive manufacturing apparatus 100 secure data related to a cartridge, to identify a compromised cartridge, to secure a material supply chain, to detect material counterfeiting or mishandling activities, etc.

### 1.3 Laser Output Optic

The laser output optic 130 of the additive manufacturing apparatus 100 outputs an intermittent energy beam from a beam generator—such as a laser diode 132—toward the build platform 122 to selectively fuse (i.e., melt) regions of a topmost surface of powdered material dispensed into the build chamber 120. Furthermore, once select regions of the topmost layer of powdered material have been fused, the laser output optic 130 can also output an intermittent energy beam from the beam generator toward the build platform 122 to selectively anneal (e.g., stress-relieve) these fused regions of the topmost layer of powdered material. Similarly, the additive manufacturing apparatus 100 can include multiple laser output optics that cooperate to project multiple energy beam simultaneously toward the build platform 122 to fuse multiple discrete regions of a topmost layer of powdered material simultaneously or one larger and/or higher-power region of the topmost layer, as described in U.S. patent application Ser. No. 14/212,875. Alternatively, the additive manufacturing apparatus 100 can include multiple laser output optics that project multiple energy beams toward the build platform 122 simultaneously, at least one energy beam fusing one region of a topmost layer of powdered material and at least one other energy beam annealing another region of the topmost layer of powdered material.

In a gantry configuration, the laser output optic 130 is suspended from a motorized gantry 126 arranged over the build platform 122, and the laser output optic 130 focuses a corresponding energy beam directly onto a topmost layer of powdered material to selectively heat, fuse, and/or anneal various regions of the layer. In one example of this configuration, the gantry 126 includes an X-axis actuator and a Y-axis actuator that cooperate to scan the laser output optic 130 over the build platform 122. In this example, the Y-axis actuator can step the X-axis actuator and the laser output optic 130(s) longitudinally across the build platform 122 as the X-axis actuator sweeps the laser output optic 130 laterally back and forth over the build platform 122. Furthermore, in this example, the Z-axis actuator 125 coupled to the build platform 122 can maintain each subsequent layer of powdered material at approximately the same vertical distance from the laser output optic 130.

In a scan mirror configuration, a first actuator scans the laser output optic 130 across and parallel to an axis of an elongated rotating mirror that is actuated by a second actuator. In this configuration, the rotating mirror reflects an energy beam output by the beam generator (e.g., laser diode 132) onto a lens below, which focuses the beam onto the topmost layer of powdered material below as the beam. In particular, first actuator scans the laser output optic 130 along the mirror in a first direction (e.g., along an X-axis), and the rotating mirror scans an energy beam—projected from the laser output optic 130—onto the lens in a second direction (e.g., along a Y-axis). In a similar configuration, the laser output optic 130 is arranged within a housing with a rotating mirror and projects an energy beam onto the rotating mirror—which is powered by a second actuator—as a first actuator scans the housing over the build platform 122. Thus, in this configuration, the laser output optic 130 focuses an energy beams onto the mirror that, while rotating, scans the energy beams across the lens. In this configuration, the additive manufacturing apparatus 100 can also include multiple beam generators (e.g., laser diodes), laser output optics, lens, mirrors, etc., which cooperate to fuse and/or anneal multiple discrete regions of a topmost layer of powdered material, to achieve a larger sintering or annealing site on a topmost layer of powdered material, and/or to achieve a greater power density at a sintering or annealing site on a topmost layer of powdered material.

However, the laser output optic 130, the beam generator (or laser diode 132), and actuators, etc. can cooperate in any other way and in any other configuration to intermittently project one or more energy beams toward a layer of powdered material dispensed over the build platform 122, thereby selectively fusing or annealing particular regions of the layer during a build cycle.

### 1.4 Processor and Sensors

One variation of the additive manufacturing apparatus 100 includes a processor 160 that control various actuators within the additive manufacturing apparatus 100 to selectively preheat, fuse, and/or anneal particular areas of each layer of powdered material dispensed over the build platform 122. For example, the processor 160 can step through lines of a machine tool program (e.g., in G-code) loaded into the additive manufacturing apparatus 100, and, for each X-Y coordinate specified in the machine tool program, the processor 160 can control a position of each of the X-, Y-, and Z-axis actuators while triggering a laser diode 132 to intermittently generate an energy beam of sufficient power to locally melt powdered material in a topmost layer on the build platform 122 at a sufficient depth to fuse with adjacent fused regions in the same layer and/or in a preceding layer. As the laser output optic 130 is rastered over the build platform 122, the processor 160 can further implement look-ahead techniques to trigger a second laser diode 132 to generate a second energy beam of sufficient power to locally preheat powdered material in the topmost layer when an upcoming X-Y coordinate specified in the machine tool program matches a current projection coordinate for a second laser output optic 130 (or lens) arranged ahead of the (first) laser output optic 130. Similarly, in this example, as the laser output optic 130 is rastered over the build platform 122, the processor 160 can implement look-behind techniques to trigger yet a third laser diode 132 to generate a third energy beam of sufficient power to locally anneal melted material in the topmost layer when a recent X-Y coordinate specified in the machine tool program matches a current projection coordinate for a third laser output optic 130 (or lens) lagging (i.e., behind) the (first) laser output optic 130. As described below, as in this example, the processor 160 can similarly control the outputs of multiple discrete laser diodes to simultaneously and selectively generate energy beams of sufficient power to preheat, melt, and/or anneal local areas of a topmost layer of powdered material. The processor 160 can also control various actuators within the additive manufacturing apparatus 100 to preheat, fuse, and/or anneal select regions of layers of powdered material—during contrustion of one structure—according to multiple machine tool programs, such as one machine tool program specific to preheating powdered material, one machine tool program specific to fusing or melting powdered material, and one machine tool program specific to annealing local regions of fused material.

Furthermore, once a series of X-Y coordinates corresponding to one Z-position in the machine tool program is completed, the processor 160 can trigger Z-axis actuator 125 to lower the build platform 122 by a specified amount (e.g., by a distance corresponding to a target layer thickness), trigger the material dispenser 180 to dispense a fresh layer of powdered material over the previous layer of powdered material, trigger the recoater blade 182 to level the dispensed material into a new layer, and then control the positions of and outputs of the laser output optics and the laser diodes according to a subsequent series of X and Y coordinates corresponding to the new Z-position of the build platform 122. Thus, in this variation, as a laser output optic 130 moves over various regions of a layer of powdered material below, a controller within the additive manufacturing apparatus 100 (i.e., the processor 160) can intermittently power a select laser diodes to project one or more energy (i.e., laser) beams onto select regions of the layer, thereby heating, melting, and/or annealing only these select regions of particular layers of dispensed powdered material.

In one variation, the additive manufacturing apparatus 100 includes an image sensor 140 arranged within the build chamber 120 and configured to output a digital image of a laser sintering (or “fuse”) site over the build platform 122. In this variation, the processor 160 can retrieve a shutter speed (or ISO speed, exposure time, aperture, integration time, sampling rate, or other imaging parameter) from the computer file associated with the cartridge 200 or calculate this imaging parameter based on a type and/or emissivity of powdered material specified in the computer file, and the processor 160 can trigger the optical sensor 140 to capture an image of a current fuse site according to the imaging parameter. The processor 160 can subsequently correlate a light intensity of a pixel within the digital image with a temperature at the fuse site, such as based on an emissivity of the powdered material as specified in the corresponding computer file, and then implement closed-loop feedback to regulate a power output of the laser diode 132 based on the calculated temperature to maintain fuse site temperatures within a threshold range of a target fuse temperature defined in the computer file (or calculated from the material type), as described in U.S. patent application Ser. No. ______. The processor 160 can similarly implement closed-loop feedback to regulate a power output of the laser diode 132 to maintain annealing site temperatures within a threshold range of a target anneal temperature defined in the computer file (or calculated from the material type). The processor 160 can further correlate light intensities of multiple other pixels or sets of pixels within the digital image with various temperature and/or a temperature gradient across a corresponding area of the layer of powdered material (including the laser sintering site) and regulate one or more operating parameters of multiple laser diodes simultaneously and accordingly. For example, in this variation, the processor 160 can control a pulse time, operating frequency or wavelength, duty cycle, or other operating parameter of one or more laser diodes within the additive manufacturing apparatus 100 to regulate preheat, fuse, and/or anneal site temperatures. However, the processor and the image sensor 140 can cooperate in any other way to detect a fuse or anneal temperature and to control components within the additive manufacturing apparatus 100 accordingly.

### 2. Cartridge and Applications

As shown in FIGS. 5A and 5B, a cartridge for dispensing powdered material into an additive manufacturing apparatus includes: a vessel 210 defining an outlet 222; an engagement feature 220 configured to transiently support the vessel 210 within an additive manufacturing apparatus; a resealable lid 230 arranged over the outlet 222 and configured to transiently engage an element within the additive manufacturing apparatus 100, the element selectively transitioning the lid between a closed setting (shown in FIG. 5A), the resealable lid 230 sealing powdered material in an inert gas environment within the vessel 210 in the closed setting, and an open setting (shown in FIG. 5B), the resealable lid 230 releasing powdered material into the vessel 210 in the open setting; and an identifier 240 stored on the vessel 210 and including a pointer to an electronic database including data specific to material contained within the vessel 210.

Generally, the cartridge 200 functions as a containment vessel 210 for powdered material and can be loaded into an additive manufacturing apparatus to supply powdered material to a build chamber 120 therein during a build cycle. In particular, the cartridge 200 can contain powdered material—such as powdered steel, aluminum, or titanium—sealed within an inert environment, thereby reducing oxidation and extending a shelf life of the powdered material. Once powdered material is dispensed from the cartridge 200 into the additive manufacturing apparatus 100 during one build cycle, the cartridge 200 can reseal any powdered material remaining therein in an inert environment such that cartridge can be removed from the additive manufacturing apparatus 100, stored without substantial degradation of the remaining powdered, and later installed in the same or different additive manufacturing apparatus to supply the remaining powdered material to the additive manufacturing apparatus 100 during a subsequent build cycle. Similarly, the additive manufacturing apparatus 100 can return loose (i.e., unused) powdered material back to the cartridge 200 upon completion of a build cycle, and the cartridge 200 can reseal this recycled powered material in an inert environment such the powdered material can be stored until use in a subsequent build cycle in the same or different additive manufacturing apparatus without substantial degradation of the powdered material from exposure to oxygen, moisture, etc. The cartridge 200 can therefore function as a vehicle for fresh and/or previously recycled powdered material to deliver discrete volumes of powdered material to a build chamber 120 within the additive manufacturing apparatus 100 during a build cycle and to seal remaining powdered material and/or recycled powdered material returned to the cartridge 200 after the build cycle such that the recycled and/or remaining material can be used again during construction of another object in a subsequent build cycle.

The cartridge 200 also contains or stores an identifier linked to data specific to the cartridge 200 and powdered material contained therein. In particular, the additive manufacturing apparatus 100 (i.e., the reader) can read the identifier 240 from the cartridge 200, pass the identifier 240 over a computer network to a cartridge database, and receive information specific to the powdered material and associated with the identifier 240, such as a fuse profile, an anneal profile, a material time, a material age, a number of recycle cycle encountered by powdered material within the cartridge 200, a source or supplier for the powdered material, history (e.g., dates, locations) of build cycles completed with the powdered material, etc., any of which can be stored in a computer file or other memory format on the database For example, the cartridge 200 can include a radio-frequency identification tag that wirelessly transmits a unique serial number—associated with a computer file specific to the cartridge 200—the additive manufacturing apparatus 100, and the additive manufacturing apparatus 100 can pass the unique serial number to the database to retrieve the computer file. In another example, a barcode or quick-response code can be printed on the cartridge 200, and the additive manufacturing apparatus 100 can read the bar code, pass data from the barcode to the database, and retrieve cartridge data specific to the barcode. The cartridge 200 can thus contain a link to material history data, material type data, and/or material-specific construction parameters stored remotely from the additive manufacturing apparatus 100 such that these material data can be stored remotely, updated across a platform of cartridges both independently and uniformly in groups, and accessed by any number of additive manufacturing apparatuses and/or users with or without direct access to the cartridge 200.

The cartridge 200 can therefore be installed in an additive manufacturing apparatus—as described above—prior to a build cycle, can dispense material into the additive manufacturing apparatus 100 during additive manufacture of a three-dimensional object, and can then be removed from the additive manufacturing apparatus 100 and discarded once emptied. Alternatively, upon completion of the build cycle or a series of build cycles performed within the additive manufacturing apparatus 100, loose powdered material within the build chamber 120 of the additive manufacturing apparatus 100 can be returned to and resealed within the cartridge 200. The cartridge 200 can then removed and later installed in the same or different additive manufacturing apparatus 100 to supply recycled powdered material for a subsequent build cycle. Additionally or alternatively, an emptied cartridge can be removed from the additive manufacturing apparatus 100 and returned to a material supplying for refilling with powdered material.

### 2.1 Vessel 210

The cartridge 200 includes a vessel 210 defining an outlet 222. Generally, the vessel 210 functions as an enclosed volume suitable for containing powdered material—such as powdered metal, powdered ceramic, or powdered plastic—and defines an outlet 222 for dispensing powdered material contained therein into the additive manufacturing apparatus 100. The vessel 210 can also define an inlet through which the cartridge 200 can be filled by a supplier and/or refilled by an additive manufacturing apparatus during a recycling procedure to return loose unused powdered material from a build chamber 120 back into the cartridge 200. Alternatively, the outlet 222 of the vessel 210 can function both as an outlet and as an inlet to dispense and receive new or recycled powdered material, respectively.

In one example, the vessel 210 includes a polymer container, such as an injection or blow molded high-density polyethylene container. Alternatively, the vessel 210 can include a blown or cast glass (e.g., borosilicate glass) container. Yet alternatively, the vessel 210 can include a drawn, spun, or fabricated sheetmetal (e.g., stainless steel) container. However, the vessel 210 can be of any other material or geometry and can be manufactured in any other suitable way.

### 2.2 Engagement Feature

The cartridge 200 includes an engagement feature 220 configured to transiently support the vessel 210 within the additive manufacturing apparatus 100. Generally, the engagement feature 220 functions to support the cartridge 200 within the additive manufacturing apparatus 100, such as against the receiver 150 or the carriage described above.

In one implementation, the engagement feature 220 includes a threaded boss encircling the outlet 222 and extending outward from the vessel 210, the threaded boss configured to thread into a threaded bore within the receiver 150 of the additive manufacturing apparatus 100. For example, the vessel 210 can include a cylindrical plastic container with a threaded shoulder that screws into the receiver 150. In another implementation, the engagement feature 220 includes a hook or eyelet that engages a shaft 152 (or linear slide) extending outward from the receiver 150 such that an operator may hang the cartridge 200 from the shaft via the engagement feature 220 and then push the suspended cartridge into the receiver 150, as described above and shown in FIG. 2. In yet another implementation, the engagement feature 220 include a seal arrange circumferentially about outlet (and/or about the vessel 210), the seal contacting the receiver 150 of the additive manufacturing apparatus 100 to seal and to support the canister within the receiver 150. In another implementation, the engagement features includes a key that engages a slot extending along the receiver 150 to guide the vessel 210 into the receiver 150. The engagement feature 220 can similarly include a slot or similar feature that engages a key support extending from the receiver 150.

The engagement feature 220 and/or the receiver 150 of the additive manufacturing apparatus 100 can also include a latch, catch, bolt, receiver, or similar structure that an operator can actuate to lock the cartridge 200 into the receiver 150. The cartridge 200 and/or the additive manufacturing apparatus 100 can also include a sensor that detects proper (or improper) installation of the cartridge 200, and the additive manufacturing apparatus 100 can handle alarms and dispensation of powdered material from the cartridge 200 according to an output of the sensor. However, the engagement feature 220 can be of any other form or geometry and interface with the receiver 150 or other element of the additive manufacturing apparatus 100 in any other suitable way.

The engagement feature 220 can also function to lock the vessel 210 to the receiver 150. For example, the engagement feature 220 can support the vessel 210 against the receiver 150 in a first vertical orientation to gravity feed powdered material into the additive manufacturing apparatus 100 during additive manufacture of the three-dimensional structure. In this example, upon completion of the build cycle, the receiver 150 can invert the cartridge 200 into a second vertical orientation vertically opposed to the first vertical orientation to gravity feed recycled powder back into the cartridge 200, the vessel 210 similarly suspended from the receiver 150 by the engagement feature 220 in the second vertical orientation.

However, the engagement feature 220 can be of any other form or geometry and can interface with the receiver 150 or other element of the additive manufacturing apparatus 100 in any other suitable way.

### 2.3 Resealable Lid

The cartridge 200 further includes a resealable lid 230 arranged over the outlet 222 and configured to transiently engage an element within the additive manufacturing apparatus 100, the element selectively transitioning the lid between a closed setting and an open setting, the resealable lid 230 sealing powdered material in an inert gas environment within the vessel 210 in the closed setting, and the resealable lid 230 releasing powdered material into the vessel 210 in the open setting. Generally, the resealable lid 230 functions to open the output vessel 210 to the receiver 150 to dispense material into the additive manufacturing apparatus 100 and to reseal over the output to isolate powdered material not dispensed from the cartridge 200 and/or loose powdered material recycled back into the cartridge 200 for subsequent storage. For example, the resealable lid 230 can form an airtight seal over the outlet 222 of the cartridge 200 when closed, but then open the cartridge 200 when open to release powdered material into the additive manufacturing apparatus 100 during a build cycle.

In one implementation, the resealable lid 230 includes a slit polymer membrane arranged across the outlet 222 and pierceable by the element to transition the resealable lid 230 from the closed setting to the open setting. In one example, the resealable lid 230 includes a silicone membrane spanning the outlet 222, which is defined on a leading face of vessel 210, such that a barb 156 arranged in a base of the receiver 150 pierces membrane as the cartridge 200 is fully inserted linearly into the receiver 150, leading face-first. In another example, the engagement feature 220 includes a threaded boss arranged circumferentially about the outlet 222 of the vessel 210, and the membrane is arranged about the threaded boss over the outlet 222. In this example, as the threaded boss is threaded into the receiver 150, a barb 156 or prong centered within a threaded bore of the receiver 150 pierces the membrane. In yet another example, once the cartridge 200 is installed in the receiver 150 (and moved into a dispense position), the material dispenser 180 moves a barb 156 or prong toward the outlet 222 of the cartridge 200 to pierce the membrane. In this implementation, upon completion of the build cycle and recycling procedure, the slit in the membrane can return to a static (or “equilibrium”) state sealed over the outlet 222 as the barb 156 or prong is withdrawn from the membrane. The cartridge 200—with contents (e.g., powdered material and inert gas environment) sealed inside—can be then manually (or automatically) removed from the receiver 150 and stored until needed for a subsequent build cycle in the same or other additive manufacturing apparatus.

In another implementation, the resealable lid 230 includes a threaded cap. In one example, the threaded cap includes a key feature that is engaged by an automated cap remover once the cartridge 200 is installed in the receiver 150. In this example, automated cap remover drives a hub onto the cap and rotates the hub to release the cap from the cartridge 200. The hub can further retain the cap such that, upon completion of the build cycle and/or a recycle procedure, the automated cap remover can drive the hub back into a threaded boss or bung on the cartridge 200 to reinstall the cap, thus sealing powdered material and an (inert) environment within.

In yet another implementation, the resealable lid 230 includes a sealable valve—such as a ball, rotary, or piston valve—arranged over the outlet 222 of the vessel 210. Generally, in this implementation, when the cartridge 200 is installed in the additive manufacturing apparatus 100, the valve engages the receiver 150 and an actuator within the receiver 150 opens the valve to release powdered material stored within the cartridge 200. The receiver 150 can also intermittently close the valve to pause dispensation of material from the cartridge 200, such as during fuse scans cycles over each layer of powdered material within the build chamber. The additive manufacturing apparatus 100 can also pump or dispense recycles material back into the cartridge 200 via the valve, and the receiver 150 can then close the valve to seal this recycled material in an inert environment within the cartridge 200. Alternatively, the cartridge 200 can include multiple sealable valves, such as one valve arranged over the outlet 222 for dispensing material from the cartridge 200, a second valve arranged over the inlet of the cartridge 200 for receiving fresh or recycled powdered material, and/or a third valve for charging the cartridge 200 with an inert gas, and each of the valves can engage the receiver 150 and can be selectively controlled by the additive manufacturing apparatus 100 accordingly.

Yet alternatively, the resealable lid 230 can include a resealable sliding door or a resealable annular aperture mechanism arranged over the outlet 222 of the cartridge, and an actuator within the receiver 150 can actively open the sliding door or the aperture mechanism once the cartridge 220 is installed in the additive manufacturing apparatus 100. As described above, the actuator can also close the sliding door or the aperture mechanism between dispensation of layers of material into the build chamber and/or upon completion of the build cycle.

However, the resealable lid 230 can be of any other form and can transiently interface with an element within the additive manufacturing apparatus 100 in any other suitable way to open and then reseal the cartridge 200.

### 2.4 Identifier

In one variation, the cartridge 200 further includes an identifier stored on the vessel 210 and defining a pointer to an electronic database including data specific to material contained within the vessel 210. Generally, the identifier 240 functions to link the cartridge 200 to a computer file stored remotely from the cartridge 200 and storing data specific to the cartridge 200 and/or to powdered material contained therein.

In one implementation, the identifier 240 includes a unique digital alphanumeric serial number or sequence stored on an RFID tag arranged on the vessel 210. In one example, the cartridge 200 can further include a polymer buffer 242 arranged on an exterior surface of the vessel 210 (shown in FIG. 5A), the RFID tag arranged over the polymer buffer 242 opposite the vessel 210 and wirelessly transmitting the unique serial number in the presence of an electromagnetic field generated by the additive manufacturing apparatus 100. In this example, the polymer buffer 242 can offset the RFID tag from the vessel 210 and powdered material within such that the vessel 210 and/or the powder to not prevent operation of the RFID tag by blocking wireless power transmission from an antenna within the additive manufacturing apparatus 100 to the RFID tag.

In a similar implementation, the identifier 240 is stored on a NFC tag similarly arranged on the vessel 210, and the additive manufacturing apparatus 100 powers the NFC tag to retrieve the identifier 240.

In another implementation, the identifier 240 is coded onto the vessel 210 in the form of a barcode, a QR code (shown in FIG. 5), or an other alphanumeric or character sequence printed directly or otherwise applied (e.g., in sticker form) onto an exterior surface of the cartridge 200. Thus, as the cartridge 200 is loaded into the receiver 150, an optical sensor, scanner, or other sensor can scan the identifier 240 from the cartridge 200.

In yet another implementation, the cartridge 200 includes a set of electrical contacts electrically coupled to memory arranged within the cartridge 200, the memory storing the identifier 240 in digital format. In this implementation, when the cartridge 200 is loaded into the receiver 150 the electrical contacts can interface with a plug or receptacle within the receiver 150 to transmit the digital identifier into the additive manufacturing apparatus 100, such as over I2C communication protocol.

However, in this variation, the identifier 240 can be stored in any other digital, alphanumeric, and/or printed symbolic format on the cartridge 200 and transmitted to the additive manufacturing apparatus 100 over any other suitable wired or wireless communication protocol in any other suitable way. Thus, as described above and below, the additive manufacturing apparatus 100 can pass the identifier 240 collected from the cartridge 200 to a remote database to retrieve a computer file corresponding to the cartridge 200 or to retrieve specific cartridge- or material-related data stored in the computer file. Alternatively, the additive manufacturing apparatus 100 can similarly implement the identifier 240 to retrieve a computer file or cartridge- or material-related data from locally memory 170 (shown in FIG. 1) or a disk drive installed in the additive manufacturing apparatus 100 or in a local computing device networked within the additive manufacturing apparatus 100.

In another variation, the cartridge 200 includes a memory module 260 that locally stores a computer file containing related cartridge- and/or material-related data. In this variation, the cartridge 200 can also include a wireless transmitter 250 or a wireless transceiver that wirelessly broadcasts the computer file or select data from the computer file directly to the additive manufacturing apparatus 100, as shown in FIG. 5A. Alternatively, the cartridge 200 can include a set of electrical contacts 270 that communicate the whole computer file or select data therefrom to the additive manufacturing apparatus 100 over a wired connection established with the additive manufacturing apparatus 100 upon insertion of the cartridge 200 into the receiver 150, as shown in FIG. 5B. In this variation, the additive manufacturing apparatus 100 can write additional data, such as build cycle data, directly to the memory module within the cartridge 200.

However, the cartridge 200 can communicate an identifier, select cartridge- or material-data, or a complete computer file specific to the cartridge 200 and/or to powdered material contained therein to the additive manufacturing apparatus 100 in any other suitable way.

### 2.4 Additional Sensors

As shown in FIG. 5A, one variation of the cartridge 200 further includes an environmental sensor 280 coupled to an interior volume of the vessel 210 and outputting a signal corresponding to an amount of oxygen detected within the vessel 210. In this variation, the environmental sensor 280 functions to detect a quality of the environment within the cartridge 200, such as an amount of oxygen (e.g., in parts per thousand) or an amount of moisture (e.g., humidity) in the cartridge 200. For example, the environmental sensor 280 can sample the environment within the cartridge 200 over time, such as once per five seconds over the lifespan of the cartridge 200 or between build cycles, and a processor within the cartridge 200 can integrate a detected percentage of oxygen and moisture within the cartridge 200 over time to calculate an oxygen exposure and a moisture exposure of the powdered material contained within. The processor can further calculate a degradation of the powdered material within the cartridge 200, such as based on a known reactivity of the powdered material in the presence of oxygen or water. The processor can thus throw a flag or trigger an alarm if the exposure to oxygen, the exposure to moisture, and/or the calculated degradation of the powdered material exceeds a stored threshold, and a wireless transmitter within the cartridge can transmit this alarm or flag to the additive manufacturing apparatus 100 to indicate to the additive manufacturing apparatus 100 that the powdered material within the cartridge 200 is not suitable for use in manufacturing a three-dimensional structure. Alternatively, the cartridge 200 can transmit any of these environment-related data to the additive manufacturing apparatus 100—such as over a wired or wireless connection to the additive manufacturing apparatus 100—and the additive manufacturing apparatus 100 can analyze these data to determine that the powdered material meets material requirements of a current or upcoming build cycle and flag or accept the cartridge 200 accordingly, as described below.

The cartridge 200 can similarly include a tamper sensor that detects compromise of the resealable lid 230, the vessel 210, or other barrier between the internal volume of the vessel 210 and the exterior of the vessel 210. In this variation, the cartridge 200 can communicate a tamper event detected by the tamper sensor directly to the additive manufacturing apparatus 100, to an operator, or to a material handling system to flag the cartridge 200 as compromised, thereby preventing use of powdered material contained therein for a subsequent build cycle. For example, the cartridge 200 can further include a digital display (e.g., an e-ink display) that updates in response to detected status changes of the cartridge 200, such as if an environment within the cartridge 200 changes passed a preset threshold (e.g., a threshold oxygen concentration in parts per thousand), if the cartridge is loaded into an additive manufacturing apparatus, if the cartridge 200 is reloaded with fresh or recycled material, etc. The cartridge 200 can also include an input region (e.g., a button) such that an operator can cycle through cartridge-related information stored locally on the cartridge 200 by selecting the input region.

However, the cartridge 200 can contain any other suitable sensor to detect a state or use of the cartridge 200 and/or powdered material contained therein, and the cartridge 200 can function in any other way to communicate a detected state or use of the cartridge 200 or the cartridge 200 contents to the additive manufacturing apparatus 100 in any other suitable way.

### 3. Method and Applications

As shown in FIG. 6, a method for constructing a three-dimensional structure within an additive manufacturing apparatus includes: reading an identifier from a cartridge transiently loaded into the additive manufacturing apparatus 100 in Block S110; initiating a build cycle in Block S150; dispensing a layer of powdered material from the cartridge 200 into a build chamber 120 of the additive manufacturing apparatus 100 in Block S160; during the build cycle, selectively fusing regions of the layer in Block S164; in response to completion of the build cycle, dispensing a volume of loose powdered material from the build chamber 120 into the cartridge 200 in Block S170; and over a computer network, updating a computer file with data pertaining to the build cycle in Block S180, the computer file specific to the cartridge 200 and accessed according to the identifier.

As shown in FIG. 7, one variation of the method includes: charging a region of the additive manufacturing apparatus 100 adjacent an outlet of a cartridge loaded into the additive manufacturing apparatus 100 with an inert gas in Block S140; unsealing the outlet of the cartridge 200 in Block S142; dispensing a layer of powdered material from the cartridge 200 through the outlet into a build chamber 120 of the additive manufacturing apparatus 100 in Block S160; during a build cycle, selectively fusing regions of the layer of powdered material in Block S164; in response to completion of the build cycle, dispensing a volume of loose powdered material from the build chamber 120 into the cartridge 200 in Block S170; charging the cartridge 200 with the inert gas in Block S172; and resealing the outlet of the cartridge 200 with the volume of loose powdered material and the inert gas in Block S174.

As shown in FIG. 8, another variation of the method includes: reading an identifier from a cartridge transiently loaded into the additive manufacturing apparatus 100 in Block S110; based on the identifier, retrieving from a computer network a laser fuse profile for powdered material contained within the cartridge 200 in Block S120; leveling a volume of powdered material dispensed from the cartridge 200 into a layer of substantially uniform thickness across a build platform 122 within the additive manufacturing apparatus 100 in Block S160; and selectively fusing regions of the layer according to a fuse parameter defined in the laser fuse profile in Block S164.

As shown in FIG. 9, yet another variation of the method includes: reading a first identifier from a first cartridge transiently loaded into the additive manufacturing apparatus 100 in Block S110; reading a second identifier from a second cartridge transiently loaded into the additive manufacturing apparatus 100 in Block S112; based on the first identifier, retrieving from a database a first build cycle history datum for powdered material contained within the first cartridge in Block S130; based on the second identifier, retrieving from the database a second build cycle history datum for powdered material contained within the second cartridge in Block S132; setting a dispense order for the first cartridge and the second cartridge based on the first build cycle history datum and the second build cycle history datum in Block S136; dispensing powdered material from the first cartridge into a build chamber 120 within the additive manufacturing apparatus 100 in Block S160; and in response to depletion of powdered material within the first cartridge, dispensing powdered material from the second cartridge into the build chamber 120 according to the dispense order in Block S162.

Generally, the method can be implemented by the additive manufacturing apparatus 100 described above to recycle loose powdered material—dispensed into a build chamber 120 but not fused into three-dimensional structure upon completion of a build cycle—back into one or more cartridges loaded in the additive manufacturing apparatus 100. In particular, the additive manufacturing apparatus 100 can implement the method to control and maintain an environment to which powdered material is exposed, including from the cartridge 200 to the build chamber 120 and back, thereby controlling degradation (e.g., oxidation) of the material and prolonging its useable lifespan. The method can additionally or alternatively be implemented by the apparatus to retrieve build parameters, material data, cartridge history data, etc. for one or more cartridges of powdered material loaded into the additive manufacturing apparatus 100. In particular, the additive manufacturing apparatus 100 can implement the method to retrieve an identifier from the cartridge 200, pass this identifier to a local or remote database, and receive corresponding build, material, and/or cartridge data. The additive manufacturing apparatus 100 can then manipulate these data according to the method to control various build parameters during additive manufacture of a three-dimensional structure therein.

### 3.1 Identifier and Corresponding Data

Block S110 of the method recites reading an identifier from a cartridge transiently loaded into the additive manufacturing apparatus 100. Generally, Block S110 functions to collect a (unique) linking the cartridge 200 (or material contained therein) to additional data pertinent to the cartridge 200 (or to material contained therein) by stored remotely from the cartridge 200. In various examples described above, Block S110 can receive a unique digital serial number from a radio-frequency identification tag arranged on the cartridge 200, or Block S110 can scan a code applied on an exterior of the cartridge 200 and translate the code into an alphanumeric identifier.

As shown in FIG. 9, one variation of the method also includes Block S112, which recites reading a second identifier from a second cartridge transiently loaded into the additive manufacturing apparatus 100. Block S112 can thus implement a method or technique like that of Block S110 to collect a identifier specific to the second cartridge and distinct from the identifier specific to the (first) cartridge. In one implementation, Block S110 reads the identifier from the first cartridge when the receiver 150 and/or carriage described above indexes the first cartridge into a dispense position, and Block S112 later reads the second identifier from the second cartridge once the first cartridge has been emptied and replaced by the second cartridge in the dispense position. Alternatively, Blocks S110 and S112 can cooperate to substantially simultaneously or immediately sequentially read identifiers from both the first and second (and other) cartridges loaded into the additive manufacturing apparatus 100. However, Blocks S110 and S112 can function in any other way to collect identifiers from corresponding cartridges loaded into the additive manufacturing apparatus 100.

Block S120 of the method recites based on the identifier, retrieving from a computer network a laser fuse profile for powdered material contained within the cartridge 200. Generally, Block S120 functions to retrieve parameters for fusing powdered material, the parameters linked to material contained within the cartridge 200 by the identifier. For example, Block S120 can pass the identifier collected in Block S110 to a remote server connected to database storing a computer file linked to each cartridge currently in operation or “in the field,” and Block S120 can receive a complete computer file or select data from the computer file to corresponds to the received identifier.

In one implementation, Block S120 receives a fuse scan speed and a laser fuse power to achieve desired melting and desired quality of fusion between grains of powdered material. In this implementation, the fuse scan speed can define a speed at which an energy beam is scanned over the build platform 122, a step-over distance between parallel scan paths, and/or look-ahead or look-behind parameters, etc. Furthermore, the laser fuse power can define a pulse time, an operating frequency or wavelength, a duty cycle, a total output power of one or a group of laser diodes, and/or any other operating parameter of one or more laser diodes arranged within the additive manufacturing apparatus 100. The additive manufacturing apparatus 100 can thus implement these parameters in Block S164 by controlling the X- and Y-axis actuators according to the fuse scan speed and related parameters and by controlling the laser diode 132(s) according to the laser fuse power and related parameters. In this implementation, Block S120 can additionally or alternatively receive a target fuse temperature or a target fuse temperature range for powdered material contained within the cartridge 200, and additive manufacturing apparatus can implement these parameters in Block S164 by detecting a maximum temperature, an average temperature, and/or a temperature gradient within fuse sites during a scan cycle—as described above—and executing closed-loop feedback to modulate a power output of a laser diode 132 and/or a scan speed of one or more actuators to achieve the target fuse temperature across various fuse sites during the scan cycle, as shown in FIG. 8.

Block S120 can similarly retrieve (from the computer network or database) a laser anneal profile to achieve desired stress-relief of previously-melted regions of powdered material. The additive manufacturing apparatus 100 can similarly implement these parameters (e.g., an anneal scan speed and a laser anneal power) in Block S164 to anneal fused regions of material—layer-by-layer—as the structure is additively manufactured.

Block S120 can also retrieve from the database a target layer thickness. Block S120 can alternatively calculate a target layer thickness based on a material type received from the database, a particulate size (e.g., 4-5 μm) received from the database, and/or a manufacturing tolerance specified in a part file queued for a current or subsequent build cycle. The additive manufacturing apparatus 100 can then implement the target layer thickness in Block S160 by indexing the platform downward by a distance corresponding to the (received or calculated) target layer thickness, dispensing a volume of material at least as great as the product of the target layer thickness and a width and length of the build platform 122, and then sweeping the recoater blade 182 across the build platform 122 to level the volume of dispensed material.

Block S120 can similarly collect build parameters corresponding to the second cartridge loaded into the additive manufacturing apparatus 100. However, Block S120 can retrieve any other relevant build parameter data associated with the identifier collected from the cartridge 200 in Block S110, and the additive manufacturing apparatus 100 can implement these parameters in any other suitable way. Alternatively, Blocks S110 and S120 can cooperate to retrieve these data directly from the cartridge 200, such as described above.

As shown in FIG. 9, in another variation, the method includes Block S130, which recites, based on the first identifier, retrieving from a database a first build cycle history datum for powdered material contained within the first cartridge. Generally, Block S130 functions to retrieve information pertaining to a history of powdered material contained in the cartridge 200.

In one implementation, Block S130 retrieves a recycle history of the cartridge 200. For example, if the cartridge 200 is new and contains fresh powdered material, Block S130 can collect a cartridge history indicating the same. Similarly, if the cartridge 200 was previously used in a build cycle to supply old powdered material to an additive manufacturing apparatus but then emptied, cleaned, and refilled with new (i.e., fresh) powdered material, the database can clear a powder history associated with the cartridge 200 and update the computer file with the date that the cartridge 200 was filled with the new powder, and Block S130 can retrieve this date in addition to an age, a supplier, and/or a number of open-and-reseal cycles, etc. of the cartridge 200. In these examples, Block S130 can thus receive an age of material contained within the cartridge 200 based on a date on which the cartridge 200 was (re)filled with fresh material.

Alternatively, if the cartridge 200 contains material that has been recycled from previous build cycles, Block S130 can collect data corresponding to these previous build cycles and data related to other cartridges supplying powdered material during these build cycles. For example, an additive manufacturing apparatus can dispense powdered material from multiple cartridges into a build chamber 120 during a build cycle, and these cartridges can contain powdered material of different ages, recycle histories, etc. However, because the material from these cartridges is dispensed into a large volume during a build cycle and may mix during transport back into the cartridges during a recycling procedure upon completion of the build cycle, one cartridge may be refilled with powdered material originally supplied to the additive manufacturing apparatus 100 by another cartridge. A computer file for a cartridge can thus be updated with histories of material contained in other cartridges supplying material to the same additive manufacturing apparatus during the same build cycle, and Block S130 can thus retrieve a history data for a cartridge that specifies all possible sources for powdered material contained within the cartridge 200. For example, if a first cartridge containing fresh material is loaded into an additive manufacturing apparatus with a second cartridge associated with a single recycle cycle, a computer file associated with the first cartridge can be updated with the single recycle history of the second cartridge as well as current build cycle data upon completion of a build cycle at the additive manufacturing apparatus 100. In this example, a third fresh cartridge can be loaded into a second additive manufacturing apparatus with the first cartridge, and a computer file associated with the third cartridge can be updated with the recycle history of the first cartridge, a recycle history of the second cartridge, and current build cycle data upon completion of a build cycle at the second additive manufacturing apparatus. Furthermore, in this example, when the third cartridge is loaded into a third additive manufacturing apparatus for a subsequent build, Block S130 can extract a maximum or average (e.g., by weight or volume) possible age, number of recycle cycles, etc. of material contained in the third cartridge.

Block S130 can also collect other data related to the cartridge 200 by the identifier, such as an origin of the material, a material manufacturer, a material manufacture date, a material ship date, a material type, cartridge tampering history, cartridge environment or leak data, etc.

In this variation, the method can similarly include Block S132, which recites based on the second identifier, retrieving from the database a second build cycle history datum for powdered material contained within the second cartridge, as shown in FIG. 9. Block S132 can thus function like Block S130 to collect a history of the second cartridge based on the second identifier.

### 3.2 Material Checks

As shown in FIG. 9, one variation of the method includes Block S134, which recites confirming the powdered material contained within the cartridge 200 for use in building the structure. Generally, Block S136 functions to check data collected for the cartridge 200 and/or material in Blocks S120, S130, and/or S132—such as material age, cycle history, material type, tampering events, or cartridge leak history—against build requirements assigned to the additive manufacturing apparatus 100 or to a build file for an upcoming build cycle. Block S136 can thus selectively authorize or avert dispensation of powdered material from one or more cartridges into the additive manufacturing apparatus 100.

In one implementation, Block S136 checks a type and an age of powdered material contained within a cartridge—as collected in Block S130—against a material type and a maximum material age specified for the three-dimensional structure in a queued build file. Thus, if material contained in the cartridge 200 exceeds a maximum age requirement or contains a material other than that specified for an upcoming build cycle, Block S136 can passively discard the cartridge 200 from supplying powdered material to the build chamber 120 for the upcoming build cycle. Block S136 can also trigger an audible and/or visual alarm to prompt an operator to remove the offending cartridge and to replace with another cartridge of appropriate material type and age.

In another implementation, Block S136 checks a recycle history of powder contained in a cartridge—as collected in Block S130—against a recycle requirement for the upcoming build cycle. For example, Block S136 can extrapolate a maximum number of possible recycle cycles completed with powdered material contained in the cartridge 200 based on a recycle history of the cartridge 200 and recycle histories of other cartridges loaded with the cartridge 200 into various additive manufacturing apparatuses during the operational history of the cartridge 200. In this example, Block S136 can compare the calculated maximum number of recycle cycles for material within the cartridge 200 to the recycle requirement defined in a queued build file and authorize or prevent material dispensation from the cartridge 200 accordingly.

In yet another implementation, Block S136 checks an environmental sensor coupled to an interior volume of the cartridge 200 against a material grade requirement associated with the upcoming or current build cycle. For example, as described above, Block S136 can include integrating an oxygen and/or moisture level detected within the cartridge 200 over time to estimate a degradation of powdered material contained within. Thus, if the interior volume of the cartridge 200 has been exposed to greater than a threshold amount of oxygen and/or a threshold amount of moisture, Block S136 can prevent dispensation of material from the cartridge 200 and/or trigger an alarm to prompt removal or replacement of the cartridge 200 from the additive manufacturing apparatus 100.

However, Block S136 can check any other material- and/or cartridge-related data collected in Block S130 against any other parameter or requirement stored in the additive manufacturing apparatus 100 or defined in a build file for a current or upcoming build cycle.

As shown in FIG. 9, in one variation, Block S136 further functions to set a dispense order for cartridges loaded into the additive manufacturing apparatus 100 based on build cycle history data collected in Block S130. In one implementation, Block S136 generates a dispense order based on a maximum (calculated) age associated with materials contained within various cartridges loaded into the additive manufacturing apparatus 100. For example, once Block S136 verifies that all cartridges loaded into the additive manufacturing apparatus 100 meet various material requirements as described above, Block S136 can select a cartridge containing the oldest powdered material to fully dispense its contents into the build chamber 120 of the additive manufacturing apparatus 100 first, followed by a second cartridge containing the next-oldest powdered material, and so on such that (potentially) oldest powdered material is used first during a build cycle. In another example, Block S136 can set the dispense order the specifies dispensation from a cartridge containing fresh and/or the youngest powdered material of all cartridges loaded into the additive manufacturing apparatus 100 such that material of a highest possible grade is used first to fuse the base of a new structure to the build platform 122 during the build cycle. In this example, Block S136 can further select a cartridge containing an oldest (and therefore potentially lowest-grade) material to dispense its contents into the build chamber 120 only for layers intersecting relatively low-stress or relatively loosely-toleranced volumes of the structure.

In another implementation, Block S136 generates a dispense order that queues dispensation of powdered material from a first cartridge prior to dispensation of powdered material from a second cartridge according to a date of a build cycle associated with powdered material within the first cartridge that precedes an oldest date of a build cycle associated with powdered material within the second cartridge. Block S136 can similarly order material dispensation from cartridges loaded into the additive manufacturing apparatus 100 based on a number of recycle cycles associated with material contained in each cartridge, such as by selecting cartridges containing material associated with a greatest number of recycle cycles for the first set of layers dispensed into the build chamber 120 or for layers corresponding to low-stress or loosely-toleranced volumes of a structure currently under construction or queued for a subsequent build cycle. However, Block S136 can function in any other way to order dispensation of material from various cartridges loaded into the additive manufacturing apparatus 100 and according to any other parameters or material value collected in Block S130.

### 3.3 Build Cycle

As shown in FIG. 6, one variation of the method includes Block S150, which recites initiating a build cycle. Generally, Block S150 functions to begin a process of preparing an internal environment within the additive manufacturing apparatus 100 for a build cycle and to begin additive manufacture of a three-dimensional structure within the build chamber 120 of the additive manufacturing apparatus 100 according to a build file (e.g., a machine tool program) loaded into the additive manufacturing apparatus 100. For example, Block S150 can arm the additive manufacturing apparatus 100 to begin a build cycle according to a select build file in response to a “cycle start” entry into the additive manufacturing apparatus 100. Block S150 can also automatically prompt the additive manufacturing apparatus 100 to implement various Blocks of the method—such as Blocks S140 and S142—in response to confirmation that build cycle history data of one or more cartridges loaded into the additive manufacturing apparatus 100 meet a material cycle limit for recycled powdered material or other material requirement specified for the three-dimensional structure, as determined in Block S136. However, Block S150 can function in any other way to initiate the build cycle.

As shown in FIG. 7, another variation of the method includes Block S140, which recites charging a region of the additive manufacturing apparatus 100 adjacent an outlet of a cartridge loaded into the additive manufacturing apparatus 100 with an inert gas. Generally, Block S140 functions to displace oxygen, moisture, and other gases or vapors within the one or more volumes of the additive manufacturing apparatus 100 that contain or contact powder dispensed from one or more cartridges to inhibit degradation of the powdered material during the build cycle. In one implementation, Block S140 purges air between the cartridge 200 and the build chamber 120 with an inert gas, such argon or nitrogen gas. For example, Block S140 can displace air between the cartridge 200 and the build chamber 120 by slowly releasing or pumping argon gas through internal volumes of the additive manufacturing apparatus 100. Block S140 can also interface within one or more environmental sensors arranged within the devices to a control a rate or supply or inert gas into the additive manufacturing apparatus 100 and to delay or trigger subsequent steps during the build cycle. However, Block S140 can function in any other way to control and maintain an environment within the additive manufacturing apparatus 100.

As shown in FIG. 7, one variation of the method further includes Block S142, which recites unsealing the outlet of the cartridge 200. Generally, Block S142 functions to open a cartridge loaded into the additive manufacturing apparatus 100 once an inert environment around an outlet of the cartridge 200 has been established (e.g., up to a threshold oxygen concentration measured in parts per thousand within the additive manufacturing apparatus 100). In one example described above, Block S142 includes puncturing a lid arranged about the outlet of the cartridge 200, thereby releasing powdered material from the cartridge 200. In another example described above, Block S142 includes removing, such as by unthreading, a lid sealed over the output of the cartridge 200 in response to a detected concentration of oxygen between the cartridge 200 and the build chamber 120 that falls bellows a threshold oxygen concentration. However, Block S142 can function in any other way to unseal the cartridge 200.

As shown in FIG. 6, one variation of the method also includes Block S160, which recites dispensing a layer of powdered material from the cartridge 200 through the outlet into a build chamber 120 of the additive manufacturing apparatus 100. Generally, Block S160 functions to dispense a volume of powdered material from the cartridge 200 and to level the volume of powdered material into a layer directly over the build or other a previous layer of powdered material dispensed into and leveled over the build platform 122. For example, Block S160 can gravity feed preset volumes of material defined in a build file or volumes of material corresponding to a target layer thickness and dimensions of the build platform 122 from the cartridge 200, through a chute, and into the build chamber 120 upon initiating of the build cycle and between scan cycles of subsequent layers of powdered material, as described above. In this example, Block S160 can also control a recoater blade 182 arranged in the build chamber 120 over the build platform 122 to level each dispensed volume of powdered material into a layer of substantially uniform thickness approximating a target layer thickness specified in the build file or in a computer file associated with the cartridge 200 or the material contained therein.

Block S160 can also pass powdered material dispensed from a cartridge through a filter arranged between the cartridge 200 and the build chamber 120 to trap particulate that is larger than a threshold maximum particulate size specified for the build cycle and/or that is smaller than a threshold minimum particulate size specified for the build cycle.

As shown in FIG. 9, in this variation, the method can also include Block S162, which recites, in response to depletion of powdered material within a first cartridge loaded into the additive manufacturing apparatus 100 (i.e., once the first cartridge is fully emptied), dispensing powdered material from a second cartridge also loaded into the additive manufacturing apparatus 100, such as according to the dispense order output in Block S136. For example, Block S162 can index the first cartridge forward from a dispense position into an empty position and index the second cartridge forward from a holding position into the dispense position. In this example, Block S162 can arcuately index a cylindrical carriage forward, wherein the cylindrical carriage supports the first cartridge and the second cartridge, and wherein the carriage orients a cartridge vertically with its outlet at a low point in the dispense position to dispense powdered material into the additive manufacturing apparatus 100, as described above. Block S162 can alternatively index loaded cartridges linearly between hold, dispense, empty, and/or reload positions, as described above. However, Block S162 can interface with any other actuator or subsystem of the additive manufacturing apparatus 100 to selectively open dispense powdered material from various cartridge loaded into the additive manufacturing apparatus 100.

As shown in FIG. 8, one variation of the method also includes Block S164, which recites, during the build cycle, selectively fusing regions of the layer. Generally, Block S164 functions to intermittently project a laser beam toward a layer of powdered material within the build chamber 120 to selectively fuse regions of the layer. For example, during a build cycle, the additive manufacturing apparatus 100 can implement Block S164 to power one or more laser diodes and/or to adjust beam focusing optics to achieve a laser power defined in the laser fuse profile collected in Block S120. In this example, Block S164 can also scan the energy beam across the layer at the fuse scan speed defined in the laser fuse profile collected in Block S120. The additive manufacturing apparatus 100 can similarly implement Block S164 to control one or more laser diodes, beam focusing optics, and/or the X- and Y-actuators to achieve a laser anneal power and/or an anneal scan speed specified in the anneal profile collected in Block S120.

In one implementation, Block S164 interfaces with an optical sensor 140 and a processor 160 to detect a temperature of a fused region of the layer and then implements closed-loop feedback to modulate a power of an energy beam projected toward a subsequent second region of the layer adjacent the first region along a scan path based on the detected temperature of the first fused region and a target fuse temperature range specified in the build file or in the laser fuse profile, as described above. Block S164 can similarly implement closed loop feedback to module a beam power, a spot size, etc. of an energy beam projected toward a layer of powdered material during an anneal cycle based on a detected temperature of an annealed site and a target anneal temperature defined in a laser anneal profile collected in Block S120, as shown in FIG. 8. Block S164 can additionally or alternatively adjust a scan speed of the energy beam during the anneal cycle according to the detected temperature of an annealed site and the target anneal temperature. However, Block S164 can function in any other way to implement a fuse and/or an anneal profile collected in Block S120.

### 3.4 Material Recycling

As shown in FIG. 7, one variation of the method includes Block S170, which recites, in response to completion of the build cycle, dispensing a volume of loose powdered material from the build chamber 120 into the cartridge 200. Generally, Block S170 functions to return loose (i.e., unfused) powdered material from the build chamber 120 back into one or more cartridges loaded into the additive manufacturing apparatus 100 such that the material can be reused in a subsequent build cycle in the same or other additive manufacturing apparatus.

In one implementation, in response to completion of a build cycle, Block S170 lowers the build platform 122 within the build chamber 120 to release loose powdered material through an exposed drainage port 128 proximal a base of the build chamber 120, as described above. Alternatively, Block S170 can release a trap door in a side of the build chamber 120 or in the build platform 122 to release loose material from the build chamber 120. Yet alternatively, Block S170 can siphon or vacuum loose powdered material out of the build chamber 120. However, Block S170 can function in any other way to actively or passively extract loose, unfused material from the build chamber 120.

In one implementation in which a cartridge is held in a single vertical orientation during a build cycle, Block S170 can elevate loose powdered material—released from the build chamber 120—back into the cartridge 200, such as through the same outlet from which material was original dispensed from the cartridge 200 or through an inlet in the cartridge 200, such as an inlet opposite the outlet such that material can be gravity-fed back into the cartridge 200. Alternatively, Block S170 can control a carriage or other actuator to invert the cartridge 200 and then actively elevate loose powder from the build chamber 120 back into the cartridge 200 through the same outlet from which material was previously dispensed from the cartridge 200. For example, Block S170 can index the cartridge 200 forward from a dispense position into a refill position. Yet alternatively, Block S170 can interface with an actuator to move the cartridge 200 from a first vertical position in which material is gravity fed from the cartridge 200 into the build chamber 120 to a second vertical position below the first vertical position to gravity feed material released from the build chamber 120 back into the cartridge 200.

In another implementation, Block S170 dispenses loose material from the build chamber 120 into a new cartridge, such as a new cartridge arranged below the build chamber 120 such that loose material can be passively dispensed (e.g., gravity-fed) from the build chamber 120 into the new cartridge.

Block S170 can also actively or passively passing loose powdered material from the build chamber 120 through a filter before dispensing the loose material into one or more cartridges, thereby removing particulate that is too large, too small, or falls outside of an acceptable particular size range from a stream of loose material fed back into the cartridge 200(s).

Block S170 can also detect a fill level of a cartridge or a volume of material dispensed back into the cartridge 200. Thus, if additional loose powder material remains in the additive manufacturing apparatus 100 when a threshold fill level for the cartridge 200 has been reached, Block S170 can switch to refilling a second cartridge. For example, Block S170 can index a refilled cartridge from a refill position to a seal position in which Block S172 and S174 cooperate to reseal the full cartridge and, in the process index an empty cartridge into the refill position. Alternatively, Block S170 can cooperate with Block S172 and S174 to seal the filled cartridge before indexing the cartridge 200 to a holding position.

However, Block S170 can function in any other way to return loose material from the build chamber 120 back into one or more cartridges loaded into the additive manufacturing apparatus 100.

As shown in FIG. 7, in this variation, the method can also include Block S172, which recites charging the cartridge 200 with inert gas. Generally, Block S172 functions to maintain or to return an interior volume of the cartridge 200 to an inert environment suitable for storing powdered material. In one implementation, Block S172 purges gas from the cartridge 200 and refills the cartridge 200 with argon, nitrogen, or an other inert gas before Block S170 dispenses material back into the cartridge 200. Alternatively, Block S172 can inject or pump an inert gas into the cartridge 200 once the cartridge 200 is fully refilled (or once the build chamber 120 is emptied of loose material) and before Block S174 reseals the cartridge 200. However, Block S172 can function in any other way to alter or preserve an inert environment within the refilled cartridge before the cartridge 200 is resealed in Block S174.

As shown in FIG. 7, in this variation, the method can therefore also include Block S174, which recites resealing the outlet of the cartridge 200, the cartridge 200 containing recycled powdered material within an inert environment. Generally, Block S174 to close the cartridge 200 in preparation for removal of the cartridge 200 from the additive manufacturing apparatus 100 and potential (long-term) storage. For example, Block S174 can interface with an actuator to return a threaded cap to a threaded outlet or a threaded bung of the cartridge 200. In another example, Block S174 interfaces with an actuator to apply an adhesive-backed polymer seal over the outlet (and/or the inlet) of the cartridge 200. In yet another example, Block S174 interface with an actuator or a passive element within the additive manufacturing apparatus 100 to lock a diaphragm arranged across the outlet (and/or the inlet) of the cartridge 200 from an open position into a closed position. However, Block S174 can function in any other way to reseal an outlet (and/or an inlet) of a cartridge filled with recycled powdered material upon completion of a build cycle.

Furthermore, in this variation, the method can include Block S180, which recites, over a computer network, updating a computer file with data pertaining to the build cycle, the computer file specific to the cartridge 200 and accessed according to the identifier, as shown in FIG. 6. Generally, Block S180 functions to write new data pertaining to the cartridge 200 and/or to material contained therein to the corresponding computer file. For example, the computer file can be stored remotely on a remote database, and Block S180 can transmit new or updated data to the remote database over a computer network. In another example the computer file is stored locally on the additive manufacturing apparatus 100, such as on a local hard drive, and Block S180 writes new or updated data to the local hard drive. In yet another example, the computer file is stored in memory on the cartridge 200, and Block S180 communicates new or updated data to the cartridge 200 via wired or wireless communication protocol.

In one implementation, once recycled material is dispensed back into a cartridge loaded into the additive manufacturing apparatus 100, Block S180 selects a computer file associated with an identifier read from the cartridge 200 (e.g., in Block S110) and updates the computer file with a date of the build cycle and a serial number corresponding to the build cycle. Block S180 can additionally or alternatively update the computer file with identifiers read from other cartridges loaded into the apparatus such that a history of material contained in the cartridge 200 can be linked—via these identifiers—to other cartridges from which material was dispensed into the additive manufacturing apparatus 100 during the build cycle. Similarly, Block S180 can retrieve all or a portion of a second computer file associated with a second cartridge loaded into the additive manufacturing apparatus 100 and append a first computer file associated with a first cartridge loaded into the additive manufacturing apparatus 100 with the whole or the portion of the second computer file, and vice versa, such that a computer file—corresponding to a cartridge containing recycled material sourced from other cartridges—reflects a substantially complete use and recycle history of all particular contained in the corresponding cartridge upon the conclusion of a build cycle.

In another implementation, Block S180 further cooperates with the optical sensor 140 and/or the process described above to update a computer file—associated with a cartridge containing recycled material—with temperature data collected during the recent build cycle. For example, Block S180 can cooperate with the optical sensor 140 to detect temperatures of unfused areas of a layer of powdered material during the build cycle, and Block S180 can then update the computer file with these detected temperatures. Thus, during a subsequent build cycle, Block S136 can correlate temperatures sustained by a powdered material—now contained within the cartridge 200—during a previous build cycle with degradation of the material and accept or reject material in the cartridge 200 for use in the subsequent build cycle accordingly. In this implementation, Block S180 can update the computer file with a maximum temperature, an average temperature, a minimum temperature, a maximum or common temperature gradient, or any other detected temperature-related parameter sustained by recycled powdered material during the recent build cycle. However, Block S180 can update a computer file for a cartridge containing recycled material with any other suitable or relevant data.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of an apparatus, laser sintering device, user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for constructing a three-dimensional structure within a laser sintering apparatus, the method comprising:
reading an identifier from a cartridge transiently loaded into the additive manufacturing apparatus;
initiating a build cycle;
dispensing a layer of powdered material from the cartridge into a build chamber of the additive manufacturing apparatus;
during the build cycle, selectively fusing regions of the layer;
in response to completion of the build cycle, dispensing a volume of loose powdered material from the build chamber into the cartridge; and
over a computer network, updating a computer file with data pertaining to the build cycle, the computer file specific to the cartridge and accessed according to the identifier.

2. The method of claim 1, wherein updating the computer file with data pertaining to the build cycle comprises writing a date of the build cycle and a serial number corresponding to the build cycle to the computer file, the computer file associated with the identifier and stored on a remote database.

3. The method of claim 1, wherein dispensing the layer of powdered material into the build chamber comprises dispensing a present volume of metal powder from the cartridge into the build chamber and leveling the preset volume of metal powder into a layer of substantially uniform thickness across a previous layer of metal powder supported by a build platform within the additive manufacturing apparatus.

4. The method of claim 1, further comprising charging a region of the additive manufacturing apparatus adjacent an outlet of the cartridge with an inert gas and puncturing a lid arranged about the outlet to unseal the outlet of the cartridge.

5. The method of claim 4, further comprising, in response to completion of the build cycle, charging the cartridge with the inert gas and resealing the outlet of the cartridge with the volume of loose powdered material and the inert gas.

6. The method of claim 4, wherein charging the region of the additive manufacturing apparatus adjacent the outlet with the inert gas comprises purging air between the cartridge and the build chamber with argon gas.

7. The method of claim 1, further comprising retrieving from the computer file a build cycle history datum for powdered material contained within the cartridge based on the identifier, wherein dispensing the layer of powdered material from the cartridge comprises dispensing the layer of powdered material from the cartridge in response to confirmation that the build cycle history datum meets a material cycle limit for recycled powdered material specified for the three-dimensional structure.

8. The method of claim 7, further comprising reading a second identifier from a second cartridge transiently loaded into the additive manufacturing apparatus, retrieving from the computer network a second build cycle history datum for powdered material contained within the second cartridge based on the second identifier, and neglecting dispensation of powdered material contained within the second cartridge according to the build cycle history datum that exceeds the material cycle limit specified for the three-dimensional structure.

9. The method of claim 1, wherein dispensing the volume of loose powdered material into the cartridge comprises indexing the cartridge forward from a dispense position into a refill position.

10. The method of claim 1, further comprising reading an environmental sensor coupled to an interior volume of a second cartridge transiently arranged within the additive manufacturing apparatus and neglecting dispensation of powdered material contained within the second cartridge according to a signal received from the environmental sensor indicating a presence of oxygen within the second cartridge exceeding a threshold oxygen concentration.

11. The method of claim 1, wherein reading the identifier from the cartridge comprises receiving a unique cartridge identifier from a radio-frequency identification tag arranged on the cartridge.

12. The method of claim 1, further comprising detecting temperatures of areas of the layer adjacent fused regions of the layer during the build cycle and updating the computer file with detected temperatures sustained within the volume of loose powdered material returned to the cartridge.

13. The method of claim 1, wherein dispensing the layer of powdered material into the build chamber comprises constraining the cartridge in a first vertical orientation to gravity feed the powdered material from an outlet of the cartridge, and wherein dispensing the volume of loose powdered material into the cartridge comprises inverting the cartridge from the first vertical orientation to gravity feed the volume of loose powdered material into the outlet of the cartridge.

14. A method for constructing a three-dimensional structure within a laser sintering apparatus, the method comprising:
charging a region of the additive manufacturing apparatus adjacent an outlet of a cartridge loaded into the additive manufacturing apparatus with an inert gas;
unsealing the outlet of the cartridge;
dispensing a layer of powdered material from the cartridge through the outlet into a build chamber of the additive manufacturing apparatus;
during a build cycle, selectively fusing regions of the layer of powdered material;
in response to completion of the build cycle, dispensing a volume of loose powdered material from the build chamber into the cartridge;
charging the cartridge with the inert gas; and
resealing the outlet of the cartridge with the volume of loose powdered material and the inert gas.

15. The method of claim 14, wherein charging the region of the additive manufacturing apparatus adjacent the outlet comprises displacing air between the cartridge and the build chamber with an inert gas, and wherein unsealing the cartridge comprises displacing a lid sealed over the output in response to a detected concentration of oxygen between the cartridge and the build chamber that falls bellows a threshold oxygen concentration.

16. The method of claim 14, wherein dispensing the layer of powdered material into the build chamber comprises leveling a present volume of metal powder, dispensed from the cartridge, across a previous layer of metal powder within the additive manufacturing apparatus, and wherein selectively fusing regions of the layer comprises intermittently projecting a laser beam toward the layer to fuse regions of metal powder within the layer.

17. The method of claim 14, wherein dispensing the volume of loose powdered material into the cartridge comprises dispensing loose powdered material into the cartridge up to a threshold fill level.

18. The method of claim 17, further comprising
dispensing from a second cartridge transiently loaded into the additive manufacturing apparatus a second layer of powdered material over the layer of powdered material,
dispensing a second volume of loose powdered material from the build chamber into the second cartridge in response to achievement of the threshold fill level within the cartridge,
charging the second cartridge with the inert gas, and
resealing an outlet of the second cartridge with the second volume of loose powdered material and the inert gas.

19. The method of claim 14, wherein dispensing the layer of powdered material into the build chamber comprises passing powdered material dispensed from the cartridge through a first filter between the cartridge and the build chamber, the first filter passing particulate less than a threshold size and retaining particulate greater than the threshold size, and wherein dispensing the volume of loose powdered material into the cartridge comprises passing the volume of loose powdered material from the build chamber through a second filter.

20. The method of claim 14, wherein dispensing the volume of loose powdered material into the cartridge comprises, in response to completion of the build cycle, lowering a build platform within the build chamber to release loose powdered material through an exposed drainage port proximal a base of the build chamber, the build platform supporting the layer, and elevating loose powdered material, emptied from the build chamber through the drainage port, into the cartridge.
